(19) United States
(12) Patent Application Publication
(10) Pub. No.: US 2015/0339644 A1
(43) Pub. Date: Nov. 26, 2015

(54) System and Method of Creating an Anonymous Customer Exercisable Call Option at a Retail Point of Sale for the Future Provision of Goods and/or Services

(71) Applicants: Deron Stults, Winter Haven, FL (US); Larry Friedman, Canton, GA (US)

(72) Inventors: Deron Stults, Winter Haven, FL (US); Larry Friedman, Canton, GA (US)

(21) Appl. No.: 14/285,549

(22) Filed: May 22, 2014

(51) Int. Cl. G06Q 20/12; G06Q 20/20

(52) U.S. Cl. CPC G06Q 20/12; G06Q 20/208

(57) ABSTRACT

One embodiment of the present invention deals generally with a system and method of selling an anonymous customer exercisable call option at a retail point of sale exercisable in the future securing the provision of goods and/or services. Such a system has the multiple advantages of: 1) Eliminating the need for the collection of customer identifying contact information such as name and address at the point-of-sale; 2) Since only a call option is sold, customers may elect to delay exercising the option, or indeed not exercise the option at all. Both of these instances likely benefit the supplier of goods and/or services in an economic sense; and, 3) The transaction may be anonymous to the maximum extent possible.

### CROSS-REFERENCE TO RELATED APPLICATIONS

This application takes benefit of U.S. Provisional App. No. 61/826,461 filed May 22, 2013 and incorporates it in its entirety.

### FIELD OF THE INVENTION

The present disclosure deals generally with a system and method of selling an option contract at a retail point of sale that when exercised provides a customer with recurring deliveries of goods and/or services over the term of the option contract. Specifically, the present disclosure deals with a system and method of selling a customer exercisable call option allowing the customer to demand the future provision of goods or services that the customer has already paid for.

### BACKGROUND OF THE INVENTION

Peel n' Pay^{SM}, Instasub^{SM}, and Instasub.com^{SM} are service marks of Opus 4, LLC.

Magazine subscriptions are a commonplace part of modern commerce. While paper “blow-in” cards are traditionally used to solicit new subscriptions and renewals more recent advances allow for a subscription to a magazine to be purchased at retail. See e.g., U.S. Pat. No. 5,926,796 (Method and Apparatus for Selling Subscriptions to Periodicals in a Retail Environment), et. seq. Obviously, such methods can be adapted to allow the retail purchase of a recurring supply of virtually any good or service. See e.g., U.S. Pat. No. 5,970,470 (System and Method for Establishing and Managing Subscription Purchase Agreements Including Commitments to Purchase Goods Over Time at Agreed Upon Prices), et. seq. However, all of these approaches offer at least two disadvantages from the point of view of the merchant and/or supplier. First, all these methods require the collection of subscriber contact information such as name and address at the point of sale. While this may be mitigated somewhat by means of a frequent shopper card or existing retail credit or customer account wherein a customer's contact information was collected a priori, inevitably new customers will appear and require collection of contact information. This is a time consuming process and disrupts customer flow at the retail point of sale. Second, all of the methods disclosed in the prior art teach various methods of creating a present, binding obligation on the part of the supplier to deliver (or to allow the customer to acquire) one or more installments of a particular good and/or service. The customer need do nothing more than purchase the obligation at the point of sale and the supplier is obligated to supply the goods and/or services under the terms of the obligation. While convenient for the customer, this is obviously disadvantageous for the supplier, because the supplier would not object if the customer did not, or was unable to, exercise the option. There are disadvantages from the point of view of the consumer also. For example, all the methods disclosed in the prior art require the customer to provide contact information or other personally identifying information to the merchant in some form or manner. In the case of particularly controversial publication or goods or services of a personal or private nature, the consumer may be reticent to provide any information at all regarding his or her identity at the point of sale and pay only using cash.

What is needed then is a system and method of creating an anonymous customer exercisable call option at a retail point of sale exercisable in the future securing the provision of goods and/or services. Such a system has the advantages of: 1) Eliminating the need for the collection of customer contact information such as name and address at the point-of-sale; 2) Since only a call option is sold, customers may elect to delay exercising the option, or indeed not exercise the option at all. Both of these instances likely benefit the supplier of goods and/or services in an economic sense; and, 3) The transaction may be anonymous to the maximum extent possible.

### BRIEF SUMMARY OF THE INVENTION

One embodiment the present invention comprises an inactivated option certificate affixable to the outside of a retail product and a system for exercising and fulfilling options subsequently exercised by a consumer. The option certificate ordinarily contains a colorful printed call to action on the exposed outside surface soliciting the consumer to purchase an option contract securing the delivery of a predetermined number of installments, or repetitive shipments, of the product and a UPC code and unique inactivated option activation code on the adhesive inside surface. Ordinarily, the option certificate is peeled from the retail product and presented to the cashier at the point-of-sale who then scans the UPC code and option activation code. The UPC code is processed by the merchant's point-of-sale system to add the appropriate purchase price to the customer's receipt. After the customer tenders payment, the merchant's point-of-sale system activates the inactivated option activation code in a web-accessible option activation database. Subsequently, the customer accesses a service provider's option redemption website via the Internet, provides the now activated option activation code, and all necessary contact information such as name and address. Presuming the tendered option activation code was accurately transcribed by the customer, the service provider then relays the consumer's contact information and option term to an appropriate fulfillment house to begin delivering products under the terms of the option certificate.

In an alternative embodiment, an option certificate is printed on, or inside, the retail product or its packaging. The option certificate of this embodiment of the present invention is ordinarily used to replace (or supplement) the conventional blow-in cards used when selling magazines and the like at retail. In this embodiment, the consumer redeems an option directly at the service provider's option redemption website. Specifically, the user logs into the option redemption website via the Internet and supplies the option activation code printed on the option certificate. The service provider option redemption website then collects all necessary consumer contact information and solicits payment before marking the option activation code as active in the service's provider's database. This prevents the customer, or another individual, from using the option activation code more than one time. The service provider then relays the consumer's contact information and option term to an appropriate fulfillment house to begin delivering products under the terms of the option certificate.

### BRIEF DESCRIPTION OF THE DRAWINGS

FIGS. 1a, 1b, and 1c are representations of the front of one embodiment of the Peel n' Pay^{SM} peelable option certificate, the back of the Peel n' Pay^{SM} peelable option certificate, and one embodiment of a single-sided printed blow-in card replacement option certificate as disclosed in the specification, respectively.

FIG. 2 is a block diagram of a system for creating an anonymous customer exercisable call option for future provision of goods and/or services at a retail point of sale and subsequently exercising the option at a later date.

FIG. 3 is a flow diagram of a method for creating an anonymous customer exercisable call option for future provision of goods and/or services at a retail point of sale.

FIG. 4 is a flow diagram of a method for exercising and causing the fulfillment of an anonymous customer exercisable call option for future provision of goods and/or services.

FIG. 5 is a block diagram of a system for manually creating and causing the fulfillment of a customer option for the provision of goods and/or services via a web connection.

FIG. 6 is a flow diagram of a method for manually creating and causing the fulfillment of a customer option for the provision of goods and/or services date via a web connection.

### DETAILED DESCRIPTION OF THE INVENTION

In the following discussion references are made to a variety of enabling technologies and techniques traditionally used to deploy software-based web services. For example, the terms “option redemption website” will denote one or more software applications or programs resident on one or more web-servers or computers and accessible by means of a conventional web browser by means of a network such as the Internet. Similarly, the term “option activation server” will denote one or more software applications or programs resident on one or more web-servers or computers that generates, and is thus accessible by, the aforementioned option redemption website by means of a network such as the Internet. Similarly, the term “option activation database” will denote one or more software applications or programs resident on one or more web-servers or computers implementing a conventional relational database and accessible by the aforementioned option activation server by means of a network such as the Internet.

Such web-based services are implemented in various ways all of which are functionally equivalent. For example, ASP.NET and C# are commonly used web development and program development languages, respectively. Those having skill in the art will recognize that there are numerous other equivalent development environments that are equally suitable. For example, PHP is a well-known web development language and compiled system service routines written in numerous compiled languages (including C#) may be freely integrated. Accordingly, it will be readily apparent that such methods of deploying web-based services are functionally equivalent to each other all such methods of implementing and deploying such systems are included in the spirit and scope of the present invention. Similarly, Microsoft® SQL is a commonly used database engine. Those having skill in the art will recognize that numerous functional equivalents such as MySQL® are readily available and that all such equivalents are included in the spirit and scope of the present invention. Finally, Microsoft® Windows® web server is but one of many commonly used web servers. Those having skill in the art will recognize that numerous functional equivalents such as Apache® are readily available and that all such equivalents are included in the spirit and scope of the present invention.

Also, various components of a conventional point-of sale (POS) system are referred to in the text and drawings, i.e. a “POS terminal”, “POS controller”, “POS printer”, and “local database” to store POS system information. Those having skill in the art will recognize that POS systems are ubiquitous in the prior art and that many combinations are available that incorporate some or all of the above described functional elements into one or more devices or systems. In this case, “POS terminal” will denote one or more pieces of physical hardware with which the customer and cashier may interact to effectuate a transaction. Typically, but without limitation, such devices: 1) Provide a facility to scan barcodes affixed to products or product packaging; 2) Allow customer or cashier to swipe credit cards, debit cards, electronic benefit cards, and the like to secure payment; 3) Allow customer or cashier to provide data, such as redemption codes, email addresses, cards, electronic benefit cards, and the like to secure payment; 4) Display and subsequently print data reflecting the cumulative purchases made by the customer during that transaction; and, 5) Transmit collected transaction data to a POS controller. In this case, “POS controller” will denote one or more programmable computational and data storage entities with which the various POS terminals interact. Typically, but without limitation, such devices: 1) Collect and forward transaction related information to payment authorization services; 2) Interact with store merchandising systems (if any) to ensure accurate prices are charged at the point-of-sale; 3) Transmit and receive collected customer identity and transaction related information to third-party customer loyalty program; and, 4) Allow for the deployment of retailer customized programs and features etc. “POS printer” will denote one or more pieces of hardware that prints paper transaction records commemorating one or more transactions processed through one or more POS terminals associated with a POS system and “local database” denotes a programmable computational and storage entity implementing a relational database storing data associated with; 1) Transactions processed through one or more POS terminals; and, 2) Custom programs or configuration data associated with the POS controller or individual POS terminals.

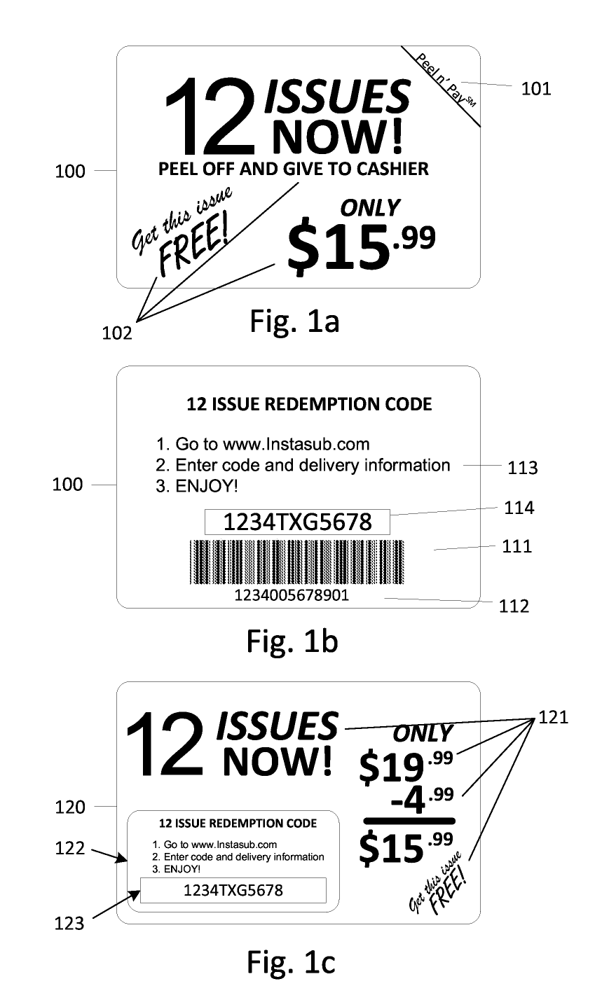

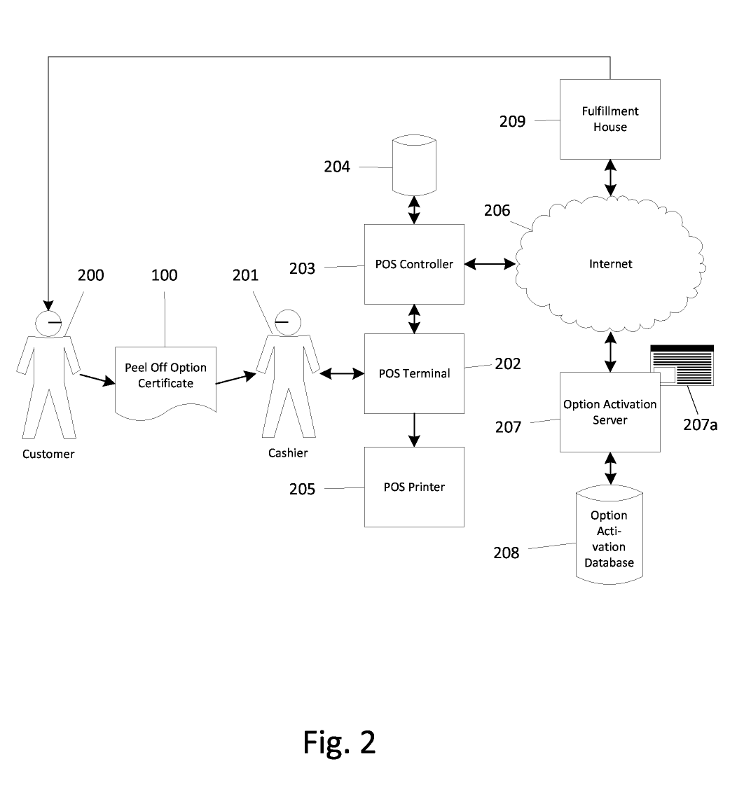

Referring now to FIGS. 1a, 1b, and 2, the front and back, respectively, of a peelable option certificate 100 of one embodiment of the present invention is shown. Printed notation 101 prompts the consumer to physically peel the Peel n' Pay^{SM} peelable option certificate 100 from the retail product to reveal the back while the balance of the front of peelable option certificate 100 contains call to action 102 generally specifying the terms of the option contract offered by the merchandise provider. It will be apparent that many other notations may appear on the face of peelable option certificate 100. For example, without limitation, a barcode such as a UPC barcode may appear on the face of peelable option certificate 100 encoding the single unit purchase price of the retail product. On the adherent back (hidden side) of peelable option certificate 100 is a barcode such as UPC barcode 111 and matching UPC numeric code 112. UPC barcode 111 is scanned by cashier 201 to capture the purchase price of the option contract (as opposed to the single installment price) in cashier 201's POS system. Alternately, cashier 201 can manually enter UPC numeric code 112 to accomplish the same task. Finally, cashier 201 manually enters textual option activation code 114 into POS terminal 202 to capture option activation code 114 in cashier 201's point-of-sale (POS) system for subsequent transmission to option activation server 207. It will be readily apparent that option activation code 114 may further comprise a supplementary linear barcode such as a UPC code or a matrix barcode such as a QR code or the like and scanned at POS terminal 202 in lieu of manual entry. Instruction area 113 generally contains instructions to customer 200 indicating how the option contract may be exercised. Ordinarily this is accomplished by means of navigating to, and interacting with, option redemption website 207a generated by option activation server 207. Once on option redemption website 207a, customer 200 is required to supply: 1) Option activation code 114; and, 2) Any necessary contact information such as name and address to effectuate fulfillment of the option contract. Without limitation option activation code 114 will ordinarily be internally coded to identify the particular product, the term of the offered option contract, and the price of the offered option contract. One having skill in the art will recognize that option activation code 114 may be internally coded with other information related to the product or its distribution. For example, without limitation option activation code 114 may designate a particular retailer, retail chain, distributor, supplier, or manufacturer. Similarly, it will be apparent that there are numerous equivalent means of navigating to option redemption website 207a—i.e. directly entering the URL in a web browser, scanning a QR code, etc. Indeed, a QR code might jointly encode the URL of option redemption website 207a and option activation code 114 to streamline access to, and use of, option redemption website 207a.

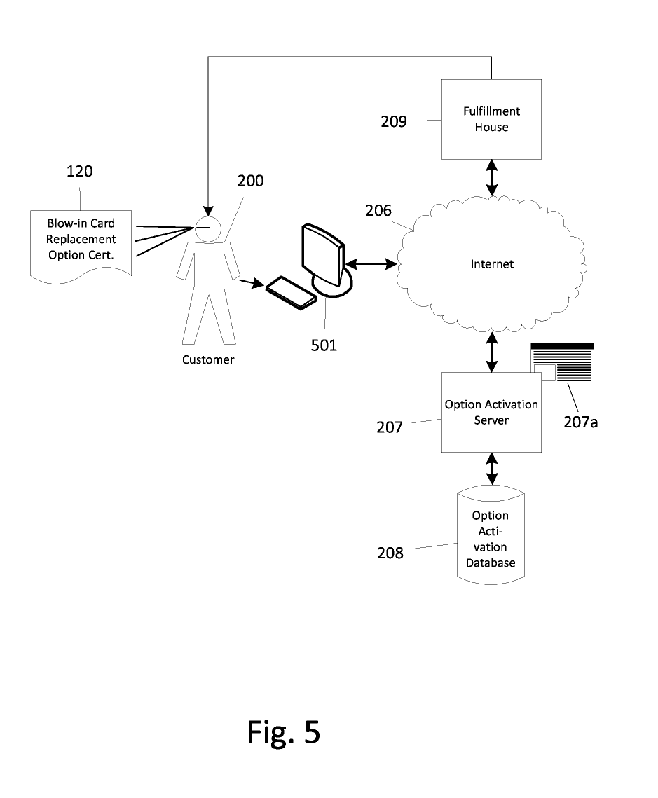

Referring now to FIGS. 1c and 5, it will be readily apparent that not only options to acquire products in the future may be sold in this manner. To the contrary, a present binding obligation exercising an option to deliver a particular retail product according to a particular schedule and at an agreed price may be sold. In this alternative embodiment, blow-in card replacement option certificate 120 need not be peelable nor need it be activated immediately at the point of sale. In this embodiment, both call to action 121 and certificate area 122 are printed on, or inside, the retail product or its packaging. As before, call to action 121 generally specifies the terms of the contract offered by the merchandise provider. Certificate area 122 contains redemption instructions as described above and text option activation code 123. As above, those having skill in the art will recognize that option activation code 123 may additionally comprise a matrix barcode such as a as a QR code or the like encoding option activation code 123. Ordinarily redemption is accomplished by means of customer 200 navigating to option redemption website 207a generated by option activation server 207. Once on option redemption website 207a, customer 200 is required to: 1) Supply option activation code 123; 2) Tender payment by means of credit card, debit card, wire transfer, third-party payer, or the like; and, 3) Provide any necessary contact information such as name and address to effectuate fulfillment of the offer. As above, without limitation option activation code 123 will ordinarily be internally coded to identify the particular product, the term of the offered option contract, and the price of the offered option contract. Also as above, one having skill in the art will recognize that option activation code 123 may be internally coded with information related to the product or its distribution. For example, without limitation option activation code 123 will ordinarily designate a particular retailer, retail chain, distributor, supplier, or manufacturer. Similarly, it will be apparent that there are numerous equivalent means of navigating to option redemption website 207a—i.e. directly entering the URL, scanning a QR code, etc. Indeed, a QR code might jointly encode the URL of option redemption website 207a and option activation code 123 to streamline access to, and use of, option redemption website 207a.

Turning now to FIGS. 1a, 1b, and FIG. 2, a block diagram of a system for creating an anonymous customer exercisable call option for future provision of goods and/or services at a retail point of sale and subsequently exercising the option at a later date is shown. Customer 200 in a retail environment secures a retail product such as a magazine, package of coffee, box of diapers, or package of batteries from the merchant's shelf. After reviewing the option contract terms printed on the exposed face of peelable option certificate 100 and further electing to create an option contract under the printed terms, customer 200 removes peelable option certificate 100 from the retail product and presents it to cashier 201. Cashier 201 scans (or manually enters) the UPC code printed on the back of peelable option certificate 100 into POS terminal 202 in the usual manner. POS terminal 202 is connected by means of a network such as the Internet 206 to POS controller 203 which in turn is connected to local database 204. Local database 204 contains program instructions executable on POS terminal 202 implementing various programs, including a program whereby cashier 201 manually enters (or scans) option activation code 114 into POS Terminal 202 and POS controller 203 subsequently transmits it to option activation server 207. Also connected to POS terminal 202 is POS printer 205, used to print a receipt for customer 200 after customer 200 has tendered payment to activate peelable option certificate 100. POS controller 203 is further connected via the Internet 206 or some similar network, to option activation server 207 which is in turn connected to option activation database 208. As alluded to above, the interaction between POS controller 203 and option activation server 207 is automatic and ordinarily proceeds in the following manner: After customer 200 has tendered payment to cashier 201, POS controller 203 contacts option activation server 207 via the Internet 206 or some similar network and causes it to mark the particular option activation code as activated for subsequent redemption in option activation database 208. After the point-of-sale transaction has been concluded, cashier 201 hands customer 200 the receipt printed by POS printer 205 returns peelable option certificate 100 to customer 200. At a subsequent time, customer 200 accesses option redemption website 207a generated by option activation server 207 and is queried for option activation code 114 printed on the printed receipt and on the back of peel off peelable option certificate 100 and any necessary contact information such as name and address to effectuate performance of the option contract. Assuming customer 200 has faithfully transcribed option activation code 114, option activation server 207 transfers the customer's contact information and purchased option term information to an appropriate fulfillment house 209 which commences periodically delivering retail product to customer 200 for the duration of the option term.

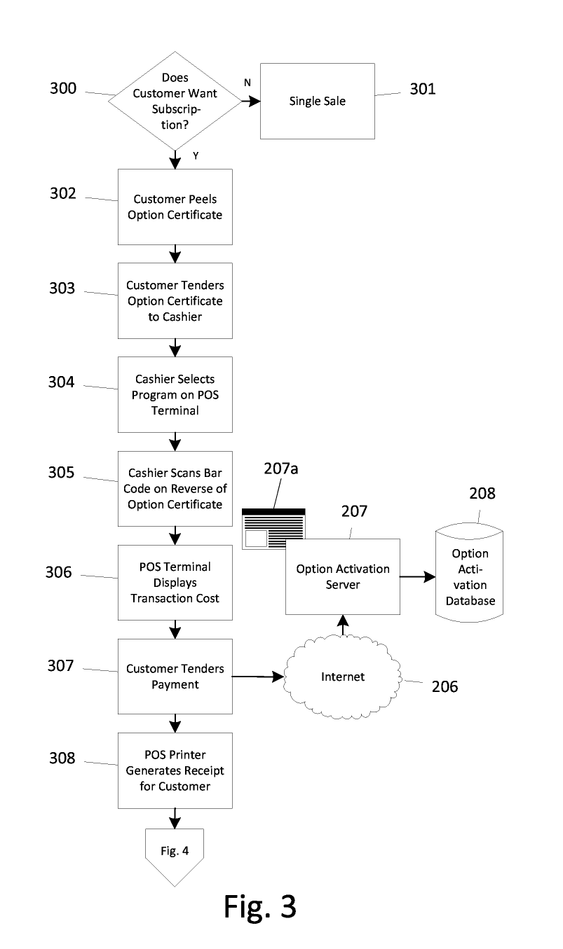

Referring now to FIGS. 1a, 1b, 2, and 3 the steps outlined in paragraph [0018] governing the creation of an anonymous customer exercisable call option for future provision of goods and/or services at a retail point of sale are discussed in greater detail. First, when customer 200 encounters a retail product equipped with peelable option certificate 100, customer 200 must decide if he or she wishes to acquire an option to receive periodic installments of the retail product via a third party fulfillment house or delivery service (300). Assuming that customer 200 does not wish to secure an option, a conventional retail transaction proceeds as it ordinarily would at the point-of-sale (301). Alternately, should customer 200 wish to acquire an option to periodically receive goods for a prescribed period of time, he or she removes peelable option certificate 100 from the retail product (302) and hands it to cashier 201 (303). Next, cashier 201 selects a program via POS terminal 202 used to collect option activation code 114 and subsequently transmit the code to option activation server 207 (304). Next, in accordance with the program just selected, cashier 201 manually enters (or scans) barcode 111 appearing on the reverse side of peelable option certificate 100 into POS terminal 202 (305). Next, after any additional retail transactions have been scanned and the customer's purchase is to be concluded, POS terminal 202 displays the total cost of the transaction to customer 200 (306). Next, customer 200 tenders payment in the usual manner and after payment has been tendered, POS controller 203 transmits a notification via the Internet 206 or some similar network to activation server 207 which subsequently marks the particular option activation code 114 as activated for subsequent redemption in option activation database 208 (307). As a last step, POS printer 205 prints a receipt for customer 200 showing, among other things, the activated option activation code 114 (308).

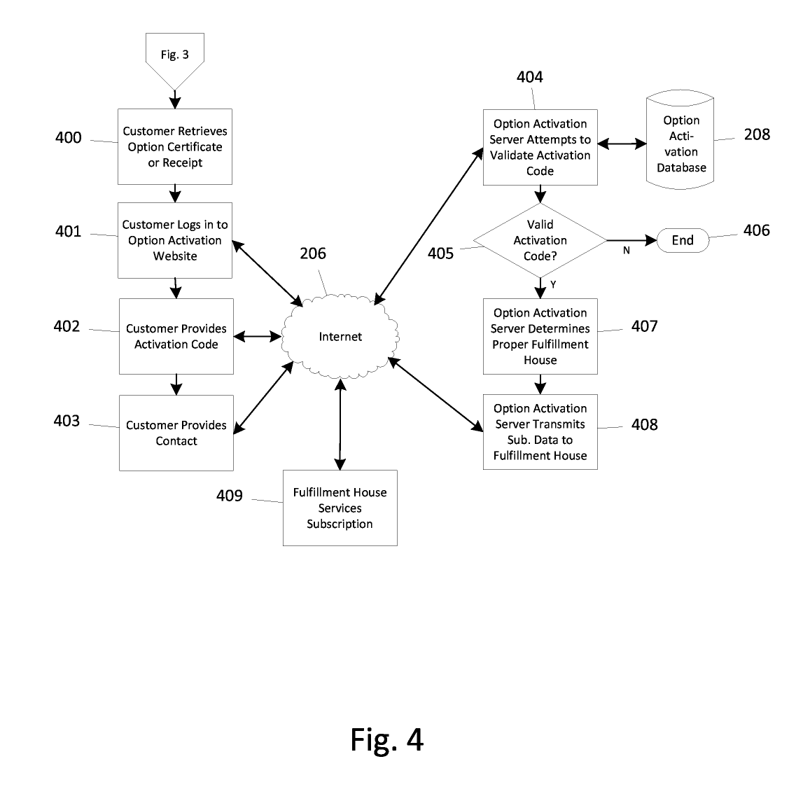

Referring now to FIGS. 1a, 1b, 2, and 4, and the steps outlined in paragraph [0018] governing the exercise and fulfillment of an anonymous customer exercisable call option for future provision of goods and/or services are discussed in greater detail. First, customer 200 retrieves peelable option certificate 100 or the printed receipt from his or her wallet, purse, or the like (400). Next, using a computer, smartphone, pad computer, or equivalent web-browser equipped device, customer 200 accesses option redemption website 207a generated by option activation server 207 (401). This may be done by directly entering the URL of option redemption website 207a into the browser, or, if option activation code 114 additionally comprises a matrix barcode such as a QR code this may be done by scanning the QR code with a smartphone app. Next, option redemption website 207a queries customer 200 for option activation code 114 printed on the back of peel off peelable option certificate 100 and/or on the printed receipt (402). Next, option redemption website 207a queries customer 200 for any necessary contact information such as name and address to effectuate fulfillment of the option contract (403). Next, option activation server 207 queries option activation database 208 to retrieve the provided option activation code 114 (404). If provided option activation 114 code is not in option activation database 208 (i.e. it was not previously activated at a retail point of sale) the process ends (405 and 406). If provided option activation code 114 is in option activation database 208 (i.e. it was previously activated at a retail point of sale) option activation server 207 determines the identity of the appropriate fulfillment house 209 associated with the particular goods/services associated with the activated option (405 and 407). Subsequently, activation server 207 transfers the customer's contact information and purchased option term information to the appropriate fulfillment house 209 (408). The fulfillment house subsequently commences periodically delivering retail product to customer 200 for the duration of the option term (409).

Turning now to FIGS. 1c and 5, a block diagram of a system for manually creating and causing the fulfillment of a present binding obligation to fulfill an option for a particular retail product delivered according to a particular schedule and at an agreed price is shown. In this embodiment, customer 200 has already acquired a particular retail product in a retail channel of distribution and wishes to exercise an option to secure future delivery of copies or installments of the same retail product. After reviewing the option contract terms printed on blow-in card replacement option certificate 120 printed on, or inside, the retail product or its packaging, and further electing to exercise an option under the printed terms, customer 200 uses a computer 501, smartphone, pad computer, or equivalent web-browser equipped device, to access option redemption website 207a generated by option activation server 207. Ordinarily this access is accomplished by means of the Internet 206 or an equivalent network. Next, option activation server 207 queries customer 200 for option activation code 123 displayed on blow-in card replacement option certificate 120 printed on, or inside, the retail product, or its packaging. Next, option redemption website 207a then queries customer 200 for a means of payment such as a credit card, debit card, bank wire transfer, third-party payer service, or the like, and any necessary contact information to effectuate fulfillment of the option contract. After payment has been made, option activation server 207 transfers the customer's contact information and purchased option term information to an appropriate fulfillment house 209 which commences periodically delivering retail product to customer 200 for the duration of the option term.

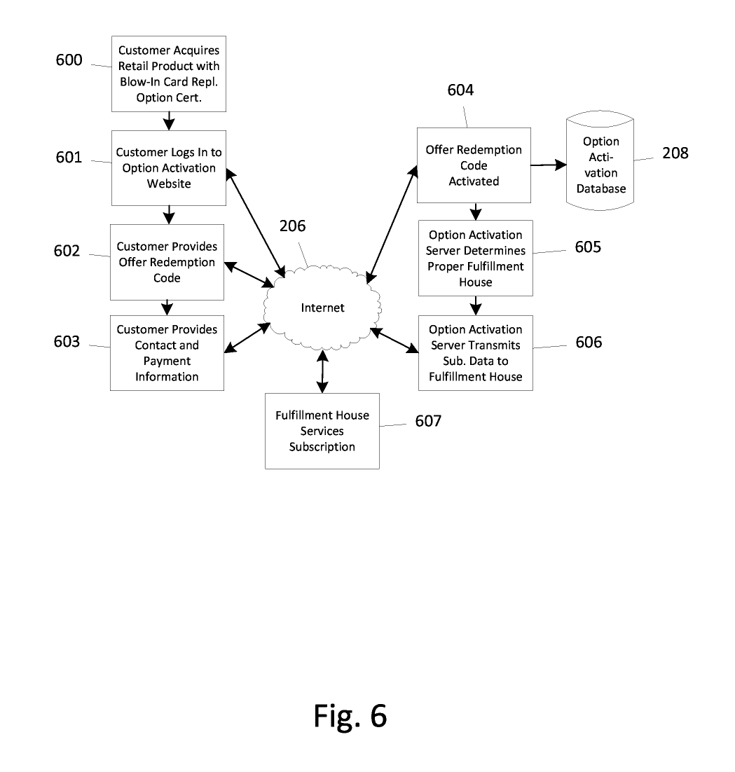

Referring now to FIGS. 1c, 5, and 6, the steps outlines in paragraph [0021] governing how customer 200 manually creates and causes the fulfillment of a customer option for the provision of goods and/or services via a web connection are discussed in greater detail. First, customer 200 acquires a retail product with blow-in card replacement option certificate 120 printed on, or inside, the retail product or its packaging (600). After deciding to exercise an option to receive periodic installments or copies of the retail product as designated on blow-in card replacement option certificate 120, customer 200 logs into option redemption website 207a generated by option activation server 207 via a network such as the Internet 206 (601). Ordinarily, this is done by directly entering the URL of option redemption website 207a into a suitable web-browser, or, if option activation code 123 additionally comprises a matrix barcode such as a QR code this may be done by scanning the QR code with a smartphone app. Next, option redemption website 207a queries customer 200 for option activation code 123 displayed on blow-in card replacement option certificate 120 printed on, or inside, the retail product or its packaging (602). Next, option redemption website 207a queries customer 200 for a means of payment such as a credit card, debit card, bank wire transfer, third-party payer service, or the like, and any necessary contact information to effectuate fulfillment of the option contract for the option term (603). Next, option activation server 207 marks the option activation code as activated in option activation database 208 to prevent subsequent reactivations using the same option activation code (604). Next, option activation server 207 determines which, from a possible multiplicity of appropriate fulfillment houses 209, to forward the newly exercised option for fulfillment (605). Next, after making this determination, option activation server 207 transfers the customer's contact information and purchased option term information to the selected appropriate fulfillment house 209 via a network such as the Internet 206 (606). Subsequently, appropriate fulfillment house 209 commences periodically delivering retail product to customer 200 for the duration of the option contract (607).

1. A system for creating at a retail point of sale an anonymous customer exercisable call option for the future provision of retail products and subsequently allowing the exercising of the option at a later date comprising:
a) a removable option certificate affixed to a retail product displaying:
i. the printed terms of the customer exercisable call option for the future provision of retail products on the visible side;
ii. a barcode and an inactivated option activation code on the hidden product adhering side;
b) an option activation database accessible by an option activation server and a point-of-sale system by means of the Internet;
c) a point-of-sale system capable of selectively:
i. capturing the barcode and effectuating the retail purchase of the customer exercisable call option for the future provision of retail products as described by the terms of the customer exercisable call option as printed on the option certificate; and capturing the inactivated option activation code and marking it as activated in the option activation database; or
ii. effectuating a conventional retail transaction as it ordinarily would at the point-of-sale to secure the purchase of the retail product without effectuating the purchase of the customer exercisable call option for the future provision of retail products;
d) an option activation server presenting an option redemption website capable of:
i. collecting a customer tendered option activation code and any necessary contact information from the purchaser;
ii. comparing the customer tendered option activation code with the activated option activation codes presently in the option activation database; and
iii. transferring the customer tendered contact information to a fulfillment house if the customer tendered option activation code is identical to one of the activated option activation codes presently in the option activation database; and
e) a fulfillment house capable of fulfilling the option.

2. The system for creating at a retail point of sale an anonymous customer exercisable call option of claim 1 wherein the barcode is a linear barcode.

3. The system for creating at a retail point of sale an anonymous customer exercisable call option of claim 1 wherein the barcode is a UPC barcode.

4. The system for creating at a retail point of sale an anonymous customer exercisable call option of claim 1 wherein the option activation code comprises text.

5. The system for creating at a retail point of sale an anonymous customer exercisable call option of claim 1 wherein the option activation code further comprises a linear barcode.

6. The system for creating at a retail point of sale an anonymous customer exercisable call option of claim 1 wherein the option activation code further comprises a UPC barcode.

7. The system for creating at a retail point of sale an anonymous customer exercisable call option of claim 1 wherein the option activation code further comprises a matrix barcode.

8. The system for creating at a retail point of sale an anonymous customer exercisable call option of claim 1 wherein the option activation code further comprises a QR code.

9. The system for creating at a retail point of sale an anonymous customer exercisable call option of claim 7 wherein the matrix barcode further encodes the URL of the option redemption website.

10. A method of using the system of claim 1 for creating an anonymous customer exercisable call option for future provision of retail products at a retail point of sale and subsequently exercising the option at a later date, comprising the steps of:
a) affixing a removable option certificate with the printed terms of the customer exercisable call option for the future provision of retail products on the visible side and a barcode and an inactivated option activation code on the hidden product adhering side to a retail product;
b) capturing the barcode on the option certificate at a POS terminal to effectuate the purchase of the anonymous customer exercisable call option while simultaneously capturing and recording the inactivated option activation code as an activated option activation code in an option activation database;
c) providing an option redemption website generated by an option activation server associated with the remotely accessible option activation database where the customer tenders the activated option activation code and any necessary contact information to the option redemption website;
d) comparing the customer tendered activated option activation code with the activated option activation codes presently in the remotely accessible option activation database;
e) transferring the customer's contact information, retail product information, and option term to a fulfillment house for fulfillment if the customer tendered option activation code is identical to an activated option activation code presently in the option activation database.

11. A system for manually creating and causing the fulfillment of an option for the provision of retail products via the Internet comprising:
a) a blow-in card replacement option certificate printed on a retail product displaying the terms of the customer exercisable option for the future provision of retail products and an inactivated option activation code;
b) an option activation database accessible to an option activation server by means of the Internet;
c) an option activation server presenting an option redemption website capable of:
i. collecting a customer tendered option activation code and any necessary contact and payment information from the purchaser;
ii. comparing the customer tendered option activation code with any previously activated option activation codes presently in the option activation database;
iii. effectuating the retail purchase of the option while simultaneously marking the customer tendered option activation code as an activated option activation code in the option activation database and transferring the customer's contact information, retail product information, and option term to a fulfillment house if the customer tendered option activation code was not previously in the option activation database; and
d) a fulfillment house capable of fulfilling the option.

12. A system for manually creating and causing the fulfillment of an option of claim 10 wherein the option activation code comprises text.

13. A system for manually creating and causing the fulfillment of an option of claim 10 wherein the option activation code further comprise a matrix barcode.

14. A system for creating at a retail point of sale an anonymous customer exercisable call option of claim 10 wherein the option activation code further comprises a QR code.

15. A system for creating at a retail point of sale an anonymous customer exercisable call option of claim 12 wherein the matrix barcode further encodes the URL of the option redemption website.

16. A method of using a system for manually creating and causing the fulfillment of an option for the provision of retail products via a web connection, comprising the steps of:
a) printing an option certificate with the terms of the customer exercisable offer for the future provision of retail products and an inactivated option activation code on a retail product;
b) selling the retail product in a retail venue with a customer purchasing the retail product;
c) providing a customer accessible option redemption website associated with a remotely accessible option activation database where the customer tenders the inactivated option activation code and any necessary contact information and payment information to the option redemption website;
d) comparing the tendered option activation code with previously activated option activation codes presently in the remotely accessible option activation database; and
e) effectuating the retail purchase of the option while simultaneously marking the customer tendered option activation code as an activated option activation code in the option activation database and transferring the customer's contact information, retail product information, and option term to a fulfillment house for fulfillment if the customer tendered option activation code was not previously in the option activation database.

17. A method of using the system of claim 1 for creating an anonymous customer exercisable call option for future provision of retail products at a retail point of sale and subsequently exercising the option at a later date, comprising the steps of:
a) affixing a removable option certificate with the printed terms of the customer exercisable call option for the future provision of retail products on the visible side and a barcode and an inactivated option activation code on the hidden product adhering side to a retail product;
b) effectuating a conventional retail transaction as it ordinarily would at the point-of-sale to secure the purchase of the retail product without effectuating the purchase of the customer exercisable call option for the future provision of retail products.
